(19) United States
(12) Patent Application Publication
(10) Pub. No.: US 2025/0362959 A1
(43) Pub. Date: Nov. 27, 2025

(54) METHOD FOR ALLOCATING SOFTWARE COMPONENTS TO A CONTROL UNIT ARCHITECTURE

(71) Applicant: Robert Bosch GmbH, Stuttgart (DE)

(72) Inventors: Christian Heissenberger, Neuhausen (DE); Matthias Freier, Ludwigsburg (DE); Sebastian Walenta, Stuttgart (DE); Simon Kramer, Leonberg (DE)

(21) Appl. No.: 18/852,035

(22) PCT Filed: Feb. 27, 2023
(86) PCT No.: PCT/EP2023/054831

§ 371 Date: Oct. 29, 2024

(30) Foreign Application Priority Data
Apr. 1, 2022 (DE) 10 2022 203 283.7

(51) Int. Cl. G06F 9/50

(52) U.S. Cl. CPC G06F 9/5027

(57) ABSTRACT

A method for allotting a group of software components to a control unit architecture having a plurality of interconnected control units. An executable software functionality is defined by a sequence chain for the group of software components. The method includes detecting, for each software component, a classification which is allocated to the particular software component, classification including at least one or more hardware-related classes which are allocated to software components, the functions of which are associated with hardware interfaces of at least one specific control unit, and wherein the classification includes at least one or more non-hardware-related classes which are allocated to software components, the functions of which are not associated with hardware elements of a specific control unit; detecting properties of the control unit architecture, wherein the detected properties include at least a number of control units and for each control unit the available resources.

### FIELD

The present invention relates to a method for allocating a group of software components to a control unit architecture, and to a corresponding control unit architecture, a computing unit and a computer program for the implementation thereof.

### BACKGROUND INFORMATION

Electronic control units are used in the automotive sector and in other areas of technology, e.g., plant control, for a variety of functions that require open-loop or closed-loop control of any kind. Typically, for example in a vehicle, there is a plurality of control units having different tasks which are networked with one another. Both the control unit architecture in the vehicle, i.e., the number and structure of the networked control units, and the software functions in the control units can be implemented in different ways. For example, a simple vehicle can have a decentralized control unit architecture which is limited to basic functions, or a higher-class vehicle can have an architecture having central control units and many extended functionalities. The hardware resources in control units are often limited for cost reasons. In principle, it is therefore desirable to allot the desired functionalities in the overall system as efficiently as possible across the available control units.

The AUTOSAR (AUTomotive Open System ARchitecture) standard is often used for the software of all types of control units. A layer architecture is used, in which the application software is abstracted from the hardware of the control unit via the so-called basic software and a runtime environment. Due to this generic approach, basic software can also be reused on similar microcontroller families, such that control units having a similar configuration can use the same basic software. For the application software, however, the problem often arises that although it could theoretically be used on other control units due to the abstraction of the layers, in practice, many functions use specific hardware interfaces of a control unit, which are addressed via the complex drivers (complex device drivers). Therefore, separate software is usually developed for each control unit, such that the software functions can often only run with the specific hardware and cannot be moved to other control units. If a shift is planned, the application software as well as the associated complex drivers often have to be redeveloped or significantly modified in order to function in a new environment.

### SUMMARY

According to the present invention, a method for allocating a group of software components to control unit architecture, as well as a corresponding control unit architecture, a computing unit and a computer program for the implementation thereof, are provided. Advantageous embodiments of the present invention are disclosed herein.

In particular, a method for allotting a group of software components to a control unit architecture having a plurality of interconnected control units is provide according to the present invention, wherein an executable software functionality is defined by a sequence chain for the group of software components. According to an example embodiment of the present invention, the method initially comprises detecting a classification for each software component from the group of software components, wherein the classification comprises at least one or more hardware-related classes which are allocated to software components, the functions of which are associated with hardware interfaces of at least one specific control unit, and wherein the classification comprises at least one or more non-hardware-related classes which are allocated to software components, the functions of which are not associated with hardware elements of a specific control unit. In addition, properties of the control unit architecture are detected, wherein the detected properties comprise at least a number of control units and for each control unit the available resources. The number of software components in the group, the classifications for each software component, the sequence chain for the software components and the properties of the control architecture are then input as input values of an optimization algorithm. In addition, additional constraints for the software components and/or the control unit architecture are input into the optimization algorithm.

As output values of the optimization algorithm, at least one unique allocation of each software component from the group of software components to the plurality of control units is then ascertained, wherein the allocation is optimized with respect to a predefined parameter for executing the executable software functionality, and wherein the allocation is performed by the optimization algorithm as a function of the classification of each of the software components.

Due to the used classification of the individual software components, hardware-related components can be better separated from non-hardware-related components. As a result, the implicit dependencies of the software components within the executable software chain can also be better broken down, allowing for simpler and more effective allotment across a plurality of control units.

This also greatly reduces the adjustment effort required when shifting software from one control unit to another.

Taking the constraints into account in the optimization method ensures that the results, i.e., the optimized allocation of software components, only produce functionalities that are actually realizable.

The predefined parameter to which the allocation is optimized can in particular comprise a latency for executing the executable software functionality and/or a uniform utilization of the resources of the control units.

According to an example embodiment of the present invention, as additional constraints for each of the software components in the optimization, one or more of the following can be used, for example: the processor load of a software component, the memory consumption of a software component, a required communication bandwidth between two software components, a required message frequency for communication between two software components, a dependency between two or more of the software components, a latency period for a software component, a communication protocol used, a hardware or software interface used by a software component.

Likewise, according to an example embodiment of the present invention, the properties of the control unit architecture and/or the additional constraints for the control unit architecture used in the optimization can comprise at least one of the following: a computing power provided by a control unit, an available memory size, a communication protocol used, a message type used, an available communication bandwidth between two control units in each case, an indication of output stages installed in a control unit, an indication of additional specific hardware interfaces in a control unit, the available inputs and outputs of a control unit, a security rating.

The presented method of the present invention can be used, for example, in a control unit architecture implemented according to the AUTOSAR standard. In particular, the hardware-related classes can then be allocated to the complex device drivers of the AUTOSAR layer structure, and the non-hardware-related classes can be allocated to the application software of the AUTOSAR layer structure. Due to the additional classification and defined interfaces between the individual classes, it is possible to execute the software components of the application software separately from the software components of the complex device drivers on different control units, which otherwise exist in AUTOSAR as a monolithic control unit-specific block.

For this refinement of the classification, the one or more hardware-related classes can be selected in possible embodiments from: a first class for software components that execute a control of hardware inputs and outputs; and a second class for software components that execute an abstraction of the hardware control.

In addition, the one or more non-hardware-related classes can be selected for classification from: a third class for software components that execute at least one of open-loop control, closed-loop control or signal processing; a fourth class for software components that execute higher-level state controls; and a fifth class for software components that form predicted values and/or perform parameter modeling. This division of the non-hardware-related and hardware-related software components makes possible a better separation of the functionalities (separation of concerns) and thus a more targeted allocation to other control units in the system, as a function of their classification and other constraints.

In particular, an evolutionary algorithm can be used as an optimization algorithm; however, other conventional optimization algorithms can also be used.

A control unit architecture according to the present invention is configured according to a method of the present invention described above. A computing unit according to the present invention, e.g., a control unit of a motor vehicle, a computer suitable for software development or a group of connected computing units, is configured, in particular in terms of programming, to carry out a method according to the present invention.

The implementation of a method according to the present invention in the form of a computer program or computer program product with program code for performing all method steps is also advantageous, since this results in particularly low costs. Finally, a machine-readable storage medium is provided with a computer program of the present invention as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can be wired or wireless (e.g., via a WLAN network or a 3G, 4G, 5G or 6G connection, etc.).

Further advantages and embodiments of the present invention can be found in the description and the figures.

The present invention is shown schematically in the figures on the basis of exemplary embodiments and is described below with reference to the figures.

### BRIEF DESCRIPTION OF THE DRAWINGS

FIG. 1 schematically shows the software architecture according to the AUTOSAR standard in the related art.

FIG. 2 shows an example of the allocation of software components to a plurality of control units, according to an example embodiment of the present invention.

FIG. 3 shows possible method steps according to exemplary embodiments of the present invention.

### DETAILED DESCRIPTION OF EXAMPLE EMBODIMENTS

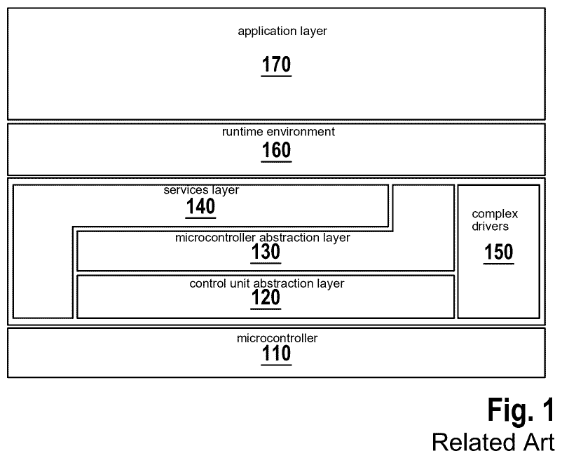

FIG. 1 schematically shows the usual layer architecture for software according to the AUTOSAR standard in the related art, as can be used, among other things, for electronic control units (ECUs) in the automotive sector. A layered abstraction of the software is provided, wherein a basic software (BSW) with various abstraction modules 120, 130, 140, 150 is used, which convey functionalities between an application layer 170 and the processing unit or the microcontroller 110 of the control unit. The runtime environment 160 (RTE), which implements the data exchange between these two layers, is located between the modules of the basic software and the application layer 170.

The basic software has a generic approach to be flexibly used on similar microcontroller families. Therefore, various modules of the basic software are defined in detail in the AUTOSAR standard. A microcontroller abstraction layer 130 (MCAL) comprises internal drivers for accessing memory, communication and input/output (I/O) of the microcontroller. An underlying control unit abstraction layer 120 (ECUAL) comprises interfaces for all functions of the control unit such as communication, memory access and input/output or pin allocations, regardless of whether these are provided by external peripheral devices or by the microcontroller. The services layer 140, as the topmost layer of the basic software, comprises background services such as communication services, system services, memory management and diagnostics.

Typically, application software uses a plurality of functionalities that require specific hardware interfaces of a particular control unit. These hardware interfaces can be implemented, among other things, via the complex drivers (complex device drivers) 150, which extend in parallel with the rest of the basic software from the hardware to the runtime environment (RTE) and are also integrated into the rest of the architecture via standardized AUTOSAR interfaces. The complex device drivers can also be used to model functions outside of the rest of the basic software, e.g. interfaces that are not directly supported by the AUTOSAR standard. In addition, the complex drivers can be used to implement time-critical functions, for example, since this allows more direct and therefore faster access to the hardware, such as sensors and actuators.

Further details of the AUTOSAR standard are known in the field and can be found at www.autosar.org. The steps and methods described below can be used in particular together with the AUTOSAR standard, but are not limited thereto and can in principle also be used in other software platforms in which an allotment of the software across a plurality of processing units is desired, wherein hardware-specific interfaces and dependencies must be taken into account.

In order to temporarily or permanently shift software components between control units in a system having a plurality of processing units, e.g., a plurality of separate control units, each of which provides different hardware resources and implements different functions, it is provided to divide a software functionality into a plurality of software components and classify them into newly defined classes. The classes for classification can be selected such that the particular individual functions and dependencies are separated from one another as far as possible (separation of concerns) with the aim of making an optimal allotment across a plurality of control units possible. Initially, a distinction can be made between hardware-related classes and non-hardware-related classes. The classes can be selected such that, in an AUTOSAR architecture, the hardware-related classes correspond to the functionality that is implemented in the complex drivers or complex device drivers, while the non-hardware-related classes correspond to the application software.

This classification can also be further refined to improve the allotment ability. Preferably, a function-specific classification is selected.

A possible division of the classes into which the software components can be classified can be structured as follows:

Hardware-related classes (complex device drivers):
a) hardware signal processing as a first class, e.g. register control for sensors and actuators or other peripheral devices; this class can in particular comprise software parts that have been developed exclusively for a particular control unit, e.g. the hardware drivers for a specific temperature sensor.
b) abstraction of the hardware signals as a second class, i.e. encapsulation for the connected sensors/actuators; this can include, for example, software parts that can also run on different, but similar, hardware, but still require adjustment, e.g. upon a change to a measuring principle, such as a changed calibration of the connected hardware.

Non-hardware-related classes (application software):
c) regulation, control, general signal processing as a third class; such as parts that perform control tasks, e.g. a PID speed control means or a feedforward control means for temperature control of a heating element, a filter of a transformer primary voltage, a noise filter of an interior vehicle camera, or a control means of a window lift motor.
d) higher-level state control as a fourth class; this includes, for example, software elements that contain state-based models or command of subsystems, e.g. a state machine for the driving modes of an inverter; software for brakes and inverters for coordination between a recuperation function and a friction brake; state control of a throttle valve; a fault diagnosis, e.g. for temperatures, voltages, signal losses, and
e) prediction and modeling calculations as a fifth class, such as software models for estimating unmeasured quantities or for predicting future system states, e.g. a temperature model of the coolant flow through a plurality of battery cells, which models the temperature of each cell while only a subset of the cells is measured. Other examples are software for estimating the wheel speed on the basis of the speed of an electric machine, the applied torque and the resulting torque, software for predicting the maximum torque in the following seconds on the basis of the current state of the drive train, or observer software for calculating the vehicle slip angle

A software functionality can then be specifically developed and optimized in a plurality of individual components according to these classes. All interfaces between these classes are to be explicitly known and defined such that data exchange is also possible across a plurality of control units. Thus, the hardware-related parts can be used separately from the non-hardware-related parts on different control units. For this purpose, the real-time capability can also be analyzed. Since signals communicate across the boundaries of the control units instead of only internally within a control unit when the software components are allocated in an allotted manner, the latencies or signal delays of the interfaces will generally increase.

The software components developed in this way can in each case be allocated to one class, in particular to one of the above-mentioned classes a) to e). On this basis, an optimal allotment of the software components across a plurality of control units can then be ascertained. For this optimization task, various parameters or constraints that are relevant for error-free and efficient execution as an allotted functionality can be taken into account.

The optimal allotment of the software components that together form a functionality can be performed using any suitable optimization algorithm, for example by means of an evolutionary algorithm. In particular, the software components together with an indication of the class into which they are classified, along with a control unit architecture, can be used as input variables for such an optimization. The control unit architecture can be defined, among other things, by the number of control units available and the available free resources for each of the control units, such as computing power, communication bandwidth or memory. For the communication bandwidth, different parameters and bandwidths can be specified for each individual connection, e.g. between a first and a second, and a first and a third control unit. The protocols and message types supported by the control units can also be defined as parameters.

As additional constraints for an optimization algorithm, for example, the memory consumption of a software component, the processor load of a component, the utilization of resources of the control units already caused by other functionalities, the communication requirements between control units (e.g., data volume, bandwidth, message frequency), a security rating, a number of digital and/or analog hardware inputs and outputs, the number and design of existing power output stages of a control unit, required communication protocols and messages (e.g., CAN frame requirements) can be defined. These and other constraints can be selected arbitrarily, in particular all or only some of the constraints can be used for optimization, or additionally or alternatively other constraints can be selected that are relevant for the utilization of the control units and the functionality of the software applications.

As optimization parameters, i.e. the goal of the optimization, in particular the response times or latencies for a functionality formed from a plurality of software components and/or a uniform utilization of the available hardware resources can be considered. A complete executable software functionality can comprise a defined sequence or chain of a plurality of software components, wherein components can also be used multiple times within the chain, e.g. particular calculation or control steps. Likewise, the software functionality need not comprise a linear chain of software components, but can comprise parallel sequences, multiple dependencies and others in the usual way. The reaction time or latency of a software functionality can then be considered as the reaction time from the start of execution to the final result (e.g., control of an actuator).

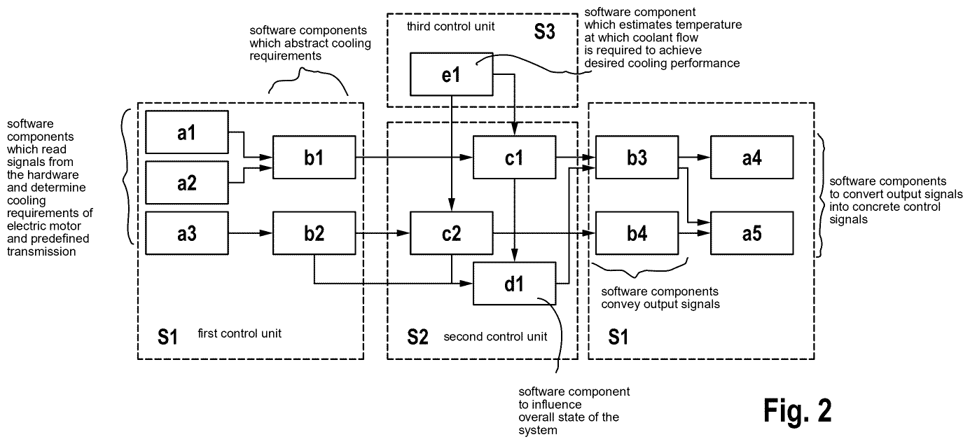

As an example, a functionality will be described below in connection with FIG. 2 that controls a coolant pump and for this purpose takes into account the cooling requirements of various parts of a drive having an electric motor. This function or application can be divided into different software components in order to make the classification described above possible. The final software functionality then comprises a particular sequence of processing steps across these different components. In this example, three interconnected control units that have different properties and can be implemented, for example, according to the AUTOSAR standard, are to be available. As already described, functions that would otherwise be allocated to the application layer (ASW) and the complex drivers (CCD) are now further divided into classes in order to make possible an optimized assignment of the software components to the control units.

Initially, three software components a1, a2, a3 can be provided, which read signals from the hardware (e.g., from temperature sensors, tachometers or other input signals) and determine the cooling requirements of the electric motor and a predefined transmission. Since direct signals, e.g. sensor signals, have to be processed here, these components can be allocated to the first class a) of software components, which comprises direct signal processing from and to sensors or actuators. Two further software components b1, b2 can be provided to abstract the cooling requirement determined by the first software components a1, a2 and a3 from the concrete components (motor, transmission, etc.), such that an abstracted cooling requirement of an electric motor and a transmission can be determined and further used by the software components b1, b2. These components can be allocated to the second class b) (encapsulation). These two classes correspond to functions that are processed in the complex device driver of the AUTOSAR architecture.

Furthermore, two software components c1, c2 can be provided as controllers in order to control a coolant pump and a passage valve in an open-loop or closed-loop manner, wherein the open-loop control is based on the cooling requirements determined by the components b1, b2. These two software components c1, c2 are allocated to the third class c) as parts of an open-loop or closed-loop control means.

As the output signals of the controllers c1 and c2, signals are received that, in turn, relate to the abstracted cooling requirement and are used as input signals for two other components, b3 and b4. These components b3 and b4 convey the output signals from the abstracted level to the concrete design of the actually existing electric motor and transmission, such that these software components, like components b1 and b2, can be allocated to the second class. The output signals are in turn converted by the components a4 and a5 into concrete control signals for actuators, namely as actuator control signals for the coolant pump and the passage valve. Thus, the software components a4 and a5 are again allocated to the first class, which comprises direct input and output signals for the hardware.

In addition, a higher-level configurable temperature model is provided in a software component e1, which can estimate at which temperature (or other input values) which coolant flow is required to achieve the desired cooling performance. As a modeling component, this software component is thus allocated to the fifth class. This model is incorporated into the controls of components c1 and c2 and could, for example, specify a target value for the coolant flow.

In addition, a software component d1 is used to influence the overall state of the system, e.g. to switch parts of the system on or off if the electric motor is not running. In the present example, this additional control element receives input values from the component b2, which transmits abstracted measured values of the electric motor, and from the two controllers c1 and c2. The output values of this control can, for example, be fed to the software component b3, which controls the coolant pump via the components a4 and a5. This component dl is thus allocated as a higher-level control component of the fourth class d).

The existing control units can comprise the same, similar and/or different properties. In this example, a first control unit that has power output stages installed for controlling the coolant pumps is to be present. In addition, the hardware-related software components, i.e. the components of the first and second class, are to be developed for this first control unit, since they must access the special hardware interfaces for the control and the received signals. In this example, a second control unit is initially intended to control the electric motor, while a third control unit is present as a central control unit. The second control unit, which controls the electric motor, can, for example, have a short latency, but only have a small communication bandwidth for the data traffic to the first control unit. In contrast, the third, central control unit can, for example, be equipped with high computing power and high communication bandwidth, but have worse latency due to its broad responsibility for many other functionalities. In addition, the constraint for the coolant control can be predefined such that, for example, after a new temperature requirement, a maximum of 120 ms is to elapse before the coolant pump is activated.

Due to the described input and output values and the dependencies between the individual components, a chain of components for the functionality to be divided is therefore predefined. Due to the allocation to the different classes, the individual software components can then be allotted to the available control units. For this purpose, a suitable optimization method such as an evolutionary algorithm can be used, for which the software components and their defining parameters, their particular allocation to the classes along with the control units and their defining parameters can be defined as input values. Additional rules can be specified as constraints, such as the communication bandwidth, the desired latency or the coupling of individual software components to a specific hardware or to a specific control unit, e.g. due to existing output stages on the control unit.

If hardware-specific software components are present, these can also initially be allocated to the control unit for which they were specifically developed. In the present example, the five software components a1, a2, a3, a4 and a5, which read the hardware signals and control the actuators and are thus allocated to the first class of software components, can be allocated to the first control unit S1 in the same way as the four software components b1, b2, b3 and b4, which perform the abstraction between the application software and the signal level and are thus allocated to the second class of software components. In the present example, the two classes are specific to the first control unit and therefore cannot be used on another control unit since, for example, the power output stages for the control by the software components a4 and a5 and the corresponding input signals for the software components a1 to a3 are missing.

The remaining software components of the third, fourth and fifth classes can then be allotted to all control units using an optimization algorithm, as already described, as a function of the available resources and other constraints. However, it is also possible that the entire allotment is performed directly via an appropriate optimization algorithm and the fixed allocation to a control unit is used as a constraint.

In this example, an allocation of the software components as shown in FIG. 2 is assumed to be the result of the optimization. Due to the hardware-specific features of the software components of the first and second classes, a1 to a5 and b1 to b4, these components are allocated to the first control unit S1. The controllers and the state control (software components c1, c2, d1), i.e. the software components of the third and fourth classes, are allocated here to the second control unit S2, in order to utilize the advantages of a central control unit. A temporal dependency between the control units can also be taken into account here. The software component el of the fifth class can be allocated as a non-critical part of the software chain (no or only low time-critical requirements) to the third control unit S3 with high computing power, for example in order to calculate highly computationally intensive models.

It is also possible that, due to an optimization process, a plurality of possible allocations of software components to control units can be found. In principle, a variety of different allocations of the software components to control units are possible. In this case, for example, all possible allocations can be output as a result, such that the developer or manufacturer can specify the final allotment. It is also possible to optimize for a single value (e.g., uniform utilization of the control units or latency period) and output the best result. Alternatively or additionally, priorities can also be specified for different values for which optimization is to be carried out. If a dynamic allocation of software components or a change in the allocation is possible, e.g. when adding another control unit to the system, a new optimal allocation can also be found for this, or the original allocation can be optimized such that a change in the control unit architecture becomes easier.

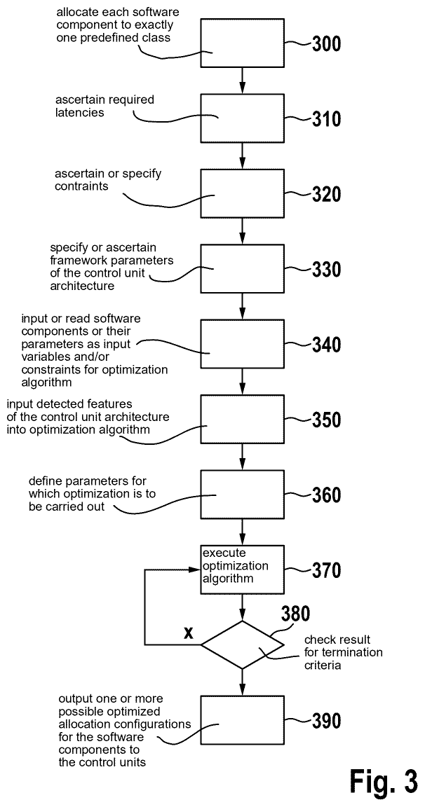

FIG. 3 shows exemplary method steps for optimizing the allotment of software components across a plurality of control units in a flow chart.

In step 300, the software components for a predefined software functionality are initially developed and each software component is allocated exactly one of the predefined classes.

In step 310, required latencies for these software components can be ascertained, and in step 320, constraints for the software components such as the expected memory consumption, a processor load, required communication protocols, required bandwidth, dependencies between the software components, required interfaces and hardware access, and others can be ascertained or specified. Such constraints can be obtained in advance, for example through measurements, test runs, estimations and optimization algorithms. For example, a maximum processor load (e.g., 80% utilization of a processing core) or a maximum bandwidth utilization (e.g., maximum 50% utilization of a CAN network) can be predefined. Constraints for memory consumption can be derived from measurements or static software analyses of the software being created. Interfaces and applications can be predefined in the application itself and, for example, be provided as a model that is automatically extracted and used to form the constraints. Concrete processor loads to be expected on a target system to which the software has not yet been ported can be ascertained, for example, from a measurement in a known system and an extrapolation by comparing the hardware. In principle, constraints can also be initially estimated manually. All data for constraints can be evaluated, for example, by an optimization algorithm.

In step 330, framework parameters of the control unit architecture can be specified or ascertained, which can comprise, among other things, the number of existing control units, the freely available computing power, the architecture or linking of the control units, the type and bandwidth of the existing communication connections, the protocols and messages used or supported, the existing analog and digital inputs and outputs, the existing power output stages and other parameters. It is understood that the steps shown here as a sequence for detecting the parameters of the software components can also be performed in a different order, independently of one another, at different times or in parallel.

The software components defined in this way or their parameters can be input or read out in step 340 as input variables and/or constraints for an optimization algorithm, e.g. from a stored file or a user input. Likewise, in step 350, the detected features of the control unit architecture can be input into the optimization algorithm. In step 360, one or more parameters for which optimization is to be carried out can be defined, e.g. a predefined latency for the execution chain of the overall functionality or a uniform utilization of resources.

The optimization algorithm is then executed in step 370 and the result is checked for a termination criterion in step 380. If the termination criterion is not met, the optimization algorithm is run again. The termination criterion can, for example, comprise the output of a plausible allocation of the software components to the control units, which takes into account all constraints fulfilled. As a result, the optimization algorithm in step 390 outputs one or more possible optimized allocation configurations for the software components to the control units, wherein each software component is to be allocated to exactly one control unit. Optionally, a plurality of allocation configurations can also be provided to a user to select from or evaluated using quality criteria. If no valid result is found with this optimization, i.e. for example, no allocation can fulfill all constraints, the method can be repeated from step 320 or optionally from a later step. In this case, for example, constraints can be changed and adjusted in order to obtain a valid allocation result.

It is understood that the features and properties of the control units mentioned here, along with all numerical values, are only given as examples and that in other cases control units with different properties, different activation times, or more or fewer available control units may be present. The function for coolant control described here also only serves to illustrate the principle of dividing software components of an application into a plurality of classes, in order to take these into account during assignment to control units, and can also be transferred to any other open-loop and closed-loop control functions with corresponding actuators, sensors, controllers and calculation steps.

1-13. (canceled)

14. A method for allotting a group of software components to a control unit architecture having a plurality of interconnected control units, wherein an executable software functionality is defined by a sequence chain for the group of software components, wherein the method comprises the following steps:
detecting, for each software component from the group of software components, a classification which is allocated to the software component, wherein the classification includes at least one or more hardware-related classes which are allocated to software components, functions of which are associated with hardware interfaces of at least one specific control unit, and wherein the classification includes at least one or more non-hardware-related classes which are allocated to software components, functions of which are not associated with hardware elements of a specific control unit;
detecting properties of the control unit architecture, wherein the detected properties include at least a number of control units and, for each control unit, the available resources;
inputting a number of the software components, the classification for each software component, the sequence chain for the software components, and the properties of the control architecture as input values of an optimization algorithm;
inputting additional constraints for the software components and/or the control unit architecture into the optimization algorithm; and
ascertaining, as an output value of the optimization algorithm, at least one unique allocation of each software component from the group of software components to the plurality of control units, wherein the allocation is optimized with respect to at least one predefined parameter or executing the executable software functionality;
wherein the allocation is performed by the optimization algorithm depending on the classification of each of the software components.

15. The method according to claim 14, wherein the predefined parameter to which the allocation is optimized includes a latency for executing the executable software functionality and/or a uniform utilization of resources of the control units.

16. The method according to claim 14, wherein the additional constraints for each of the software components include at least one of the following: a processor load of a software component, a memory consumption of a software component, a required communication bandwidth between two software components, a required message frequency for communication between two software components, a dependency between two or more of the software components, a latency period for a software component, a communication protocol used, a hardware or software interface used by a software component.

17. The method according to claim 14, wherein the properties of the control unit architecture and/or the additional constraints for the control unit architecture include at least one of the following: a computing power provided by a control unit, an available memory size, a communication protocol used, a message type used, an available communication bandwidth between two control units in each case, an indication of output stages installed in a control unit, an indication of additional specific hardware interfaces in a control unit, the available inputs and outputs of a control unit, a security rating.

18. The method according to claim 14, wherein the plurality of control units are implemented according to an AUTOSAR standard.

19. The method according to claim 18, wherein the hardware-related classes are allocated to complex device drivers of a AUTOSAR layer structure, and wherein the non-hardware-related classes are allocated to application software of the AUTOSAR layer structure.

20. The method according to claim 14, wherein the one or more hardware-related classes are selected from:
a first class for software components that control hardware inputs and outputs; and
a second class for software components that perform an abstraction of the hardware control.

21. The method according to claim 14, wherein the at least one or more non-hardware-related classes are selected from:
a third class for software components that perform at least one of open-loop control or closed-loop control or signal processing;
a fourth class for software components that perform higher-level state controls; and
a fifth class for software components that form predictive values and/or perform parameter modeling.

22. The method according to claim 14, wherein the optimization algorithm is an evolutionary algorithm.

23. A control unit architecture, comprising:
a plurality of interconnected control units, wherein a group of software components is configured so as to be allotted across the control units, wherein an executable software functionality is defined by a sequence chain for the group of software components, and wherein the allocation of the software components to the control units was carried out by:
detecting, for each software component from the group of software components, a classification which is allocated to the software component, wherein the classification includes at least one or more hardware-related classes which are allocated to software components, functions of which are associated with hardware interfaces of at least one specific control unit, and wherein the classification includes at least one or more non-hardware-related classes which are allocated to software components, functions of which are not associated with hardware elements of a specific control unit,
detecting properties of the control unit architecture, wherein the detected properties include at least a number of control units and, for each control unit, the available resources,
inputting a number of the software components, the classification for each software component, the sequence chain for the software components, and the properties of the control architecture as input values of an optimization algorithm,
inputting additional constraints for the software components and/or the control unit architecture into the optimization algorithm, and
ascertaining, as an output value of the optimization algorithm, at least one unique allocation of each software component from the group of software components to the plurality of control units, wherein the allocation is optimized with respect to at least one predefined parameter or executing the executable software functionality,
wherein the allocation is performed by the optimization algorithm depending on the classification of each of the software components.

24. A computing unit which is configured to allot a group of software components to a control unit architecture having a plurality of interconnected control units, wherein an executable software functionality is defined by a sequence chain for the group of software components, wherein the computing unit configured to:
detect, for each software component from the group of software components, a classification which is allocated to the software component, wherein the classification includes at least one or more hardware-related classes which are allocated to software components, functions of which are associated with hardware interfaces of at least one specific control unit, and wherein the classification includes at least one or more non-hardware-related classes which are allocated to software components, functions of which are not associated with hardware elements of a specific control unit;
detect properties of the control unit architecture, wherein the detected properties include at least a number of control units and, for each control unit, the available resources;
input a number of the software components, the classification for each software component, the sequence chain for the software components, and the properties of the control architecture as input values of an optimization algorithm;
input additional constraints for the software components and/or the control unit architecture into the optimization algorithm; and
ascertain, as an output value of the optimization algorithm, at least one unique allocation of each software component from the group of software components to the plurality of control units, wherein the allocation is optimized with respect to at least one predefined parameter or executing the executable software functionality;
wherein the allocation is performed by the optimization algorithm depending on the classification of each of the software components.

25. A non-transitory machine-readable storage medium on which is stored a computer program for allotting a group of software components to a control unit architecture having a plurality of interconnected control units, wherein an executable software functionality is defined by a sequence chain for the group of software components, the computer program, when executed by a computer, causing the computer to perform the following steps:
detecting, for each software component from the group of software components, a classification which is allocated to the software component, wherein the classification includes at least one or more hardware-related classes which are allocated to software components, functions of which are associated with hardware interfaces of at least one specific control unit, and wherein the classification includes at least one or more non-hardware-related classes which are allocated to software components, functions of which are not associated with hardware elements of a specific control unit;
detecting properties of the control unit architecture, wherein the detected properties include at least a number of control units and, for each control unit, the available resources;
inputting a number of the software components, the classification for each software component, the sequence chain for the software components, and the properties of the control architecture as input values of an optimization algorithm;
inputting additional constraints for the software components and/or the control unit architecture into the optimization algorithm; and
ascertaining, as an output value of the optimization algorithm, at least one unique allocation of each software component from the group of software components to the plurality of control units, wherein the allocation is optimized with respect to at least one predefined parameter or executing the executable software functionality;
wherein the allocation is performed by the optimization algorithm depending on the classification of each of the software components.
